(19) United States
(12) Patent Application Publication
(10) Pub. No.: US 2007/0284061 A1
(43) Pub. Date: Dec. 13, 2007

(54) Light regulation structure for slats of shades

(76) Inventor: Chin-Fu Chen, Taichung City (TW)

Correspondence Address: BIRCH STEWART KOLASCH & BIRCH, PO BOX 747, FALLS CHURCH, VA, 22040-0747, US

(21) Appl. No.: 11/447,990

(22) Filed: Jun. 7, 2006

(51) Int. Cl. E06B 9/307

(52) U.S. Cl. 160/176.1 R

(57) ABSTRACT

A light regulation structure for slats of shades includes an upper rail, a check pulley and a pair of anchor pulleys on each of two sides on the bottom of the upper rail to be wound by a first and a second light regulation rope, and a plurality of transverse slats located beneath the upper rail. Each of the slats has a blade type fastening element on the left side and right side. The fastening element has a thread hole to be threaded through by the first or second light regulation rope. The fastening element has a retaining ring. By pulling the first and second light regulation ropes, the slats can be tilted to regulate light projection.

### FIELD OF THE INVENTION

The present invention relates to a light regulation structure for slats of roman shades or rolling shades and particularly to a simple structure that has light regulation ropes movable to tilt the slats simultaneously to block light.

### BACKGROUND OF THE INVENTION

The conventional pendant rolling shade as shown in FIG. 1 mainly includes a shade 1 made of fiber fabrics or bamboo strips, a rolling cord 2 located respectively on a left side and a right side, and a wooden bar 3 on a lower side. By pulling the rolling cord 2, the wooden bar 3 can be moved upwards to roll the shade 1 to become a barrel to retract the shade on the top of a window.

However, such a structure cannot provide a desired dimming or light regulation effect. Once the shade 1 is lowered, it completely blocks light from entering indoors. When the shade is rolled upwards, light fully projects indoors. Rolling the shade 1 at a desired elevation by pulling the rolling cord 2, the lower portion of the window not being covered by the shade can receive light, while the upper portion of the window covered by the shade 1 blocks the light. But it frequently happens that to cover the lower portion of the window is required to protect the privacy while maintain air circulation and light projection on the upper portion of the window. The conventional rolling shade or roman shade is hung from a upper location to a lower location. As the shade 1 is an one piece panel and cannot provide angular adjustment, it is not widely accepted on the market.

### SUMMARY OF THE INVENTION

The primary object of the present invention is to provide a light regulation structure for slats of shades that has a transverse upper rail which has a check pulley and a pair of anchor pulleys on a front side and a rear side on each of two sides of the bottom surface in a pendant manner to be wound by a first and a second light regulation rope and a first and a second lift cord, a plurality of transverse slats located beneath the upper rail each has a blade type fastening element on a left side and a right side fastened to the top surface of the slat and a sleeve which has a radial thread hole to be threaded by the first or second light regulation rope. The fastening element has a retaining ring on an outer side. By pulling the first and second light regulation ropes, the slats can be tilted simultaneously or horizontally to regulate light projection. The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional pedant rolling shade.

FIG. 2 is a front perspective view of an embodiment of the present invention.

FIG. 3 is a rear perspective view of the upper rail of an embodiment of the present invention.

FIG. 4A is a rear perspective view of an embodiment of the present invention.

FIG. 4B is a fragmentary enlarged view according to FIG. 4A.

FIG. 5A is an exploded view of an embodiment of the slat of the present invention.

FIG. 5B is a fragmentary enlarged view according to FIG. 5A.

FIG. 6 is a schematic view of an embodiment of the present invention in a horizontal condition to receive light.

FIG. 7 is a schematic view of an embodiment of the present invention in a folding condition to block light.

FIG. 8 is a schematic view of an embodiment of the present invention in a rolled and retracted condition.

FIG. 9A is a front perspective view of another embodiment of the present invention.

FIG. 9B is a fragmentary enlarged view according to FIG. 9A.

FIG. 10 is perspective view of another embodiment of the present invention in a retracted condition.

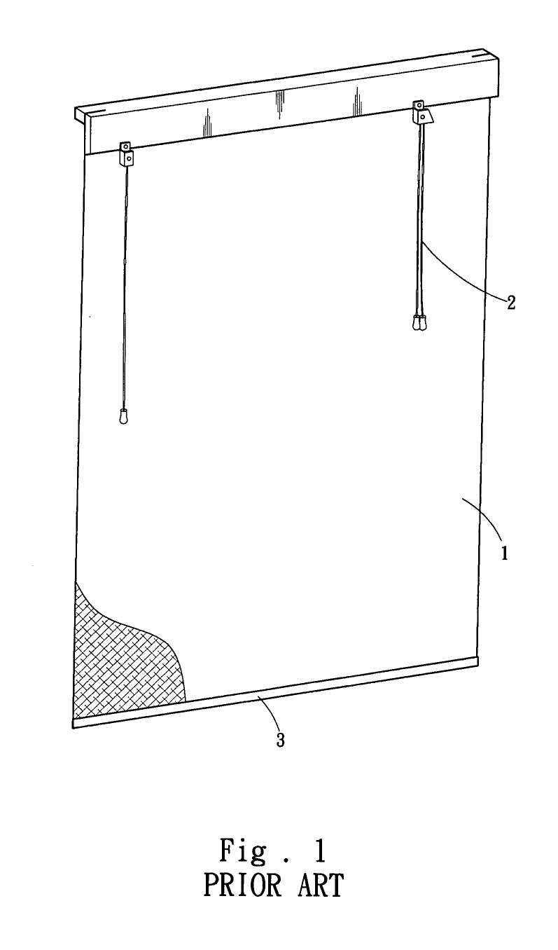

### DETAILED DESCRIPTION OF THE PREFERRED EMBODIMENT

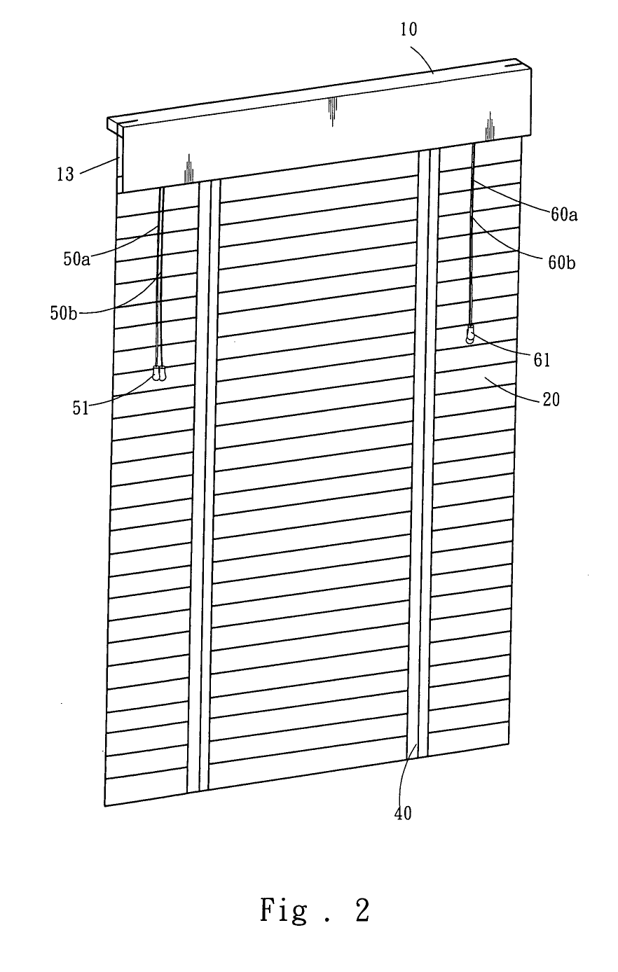

Please refer to FIG. 2, the light regulation structure for slats of shades according to the invention mainly includes:

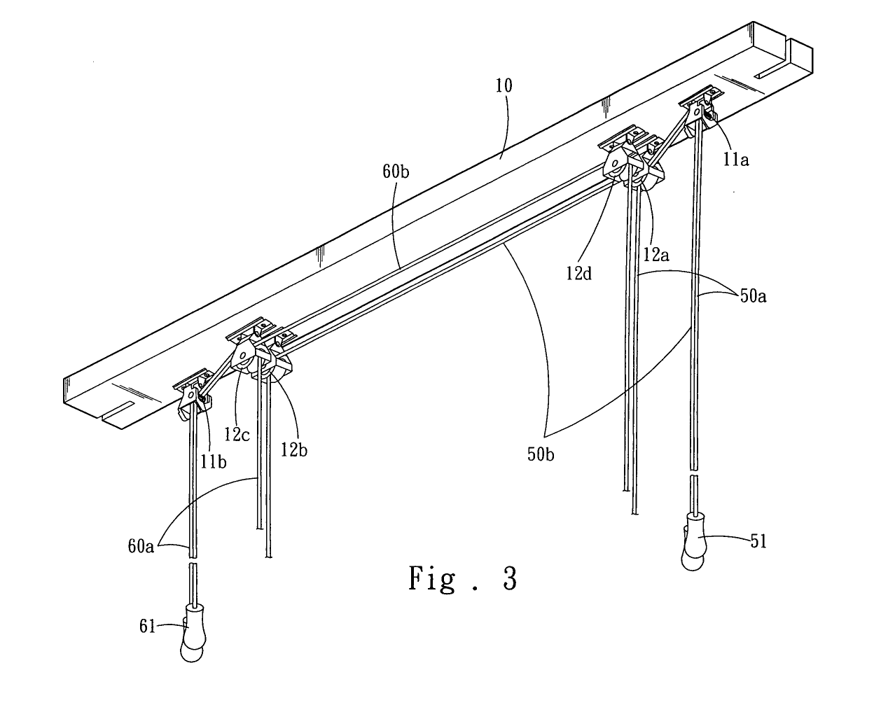

an upper rail 10 (as shown in FIG. 3) which has respectively a check pulley 11a and 11b on the left side and the right side in a pedant manner, and a pair of anchor pulleys 12a, 12d, 12c and 12b on a front side and a rear side close to an inner side of the check pulley, and a face panel 13 on the bottom thereof;

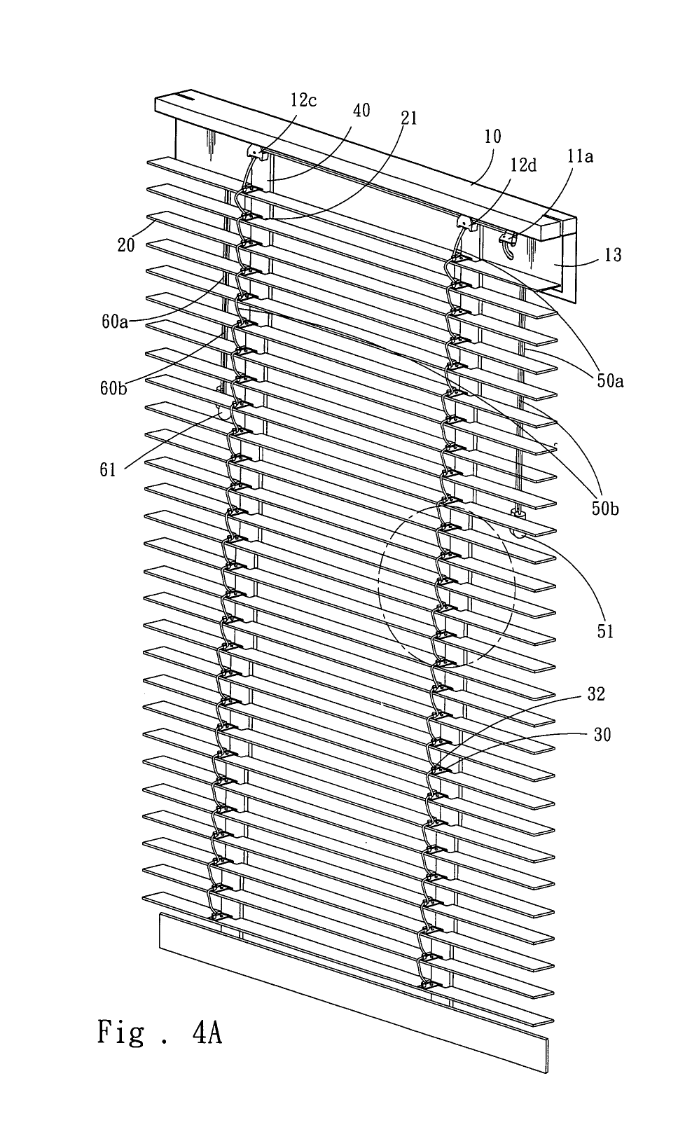

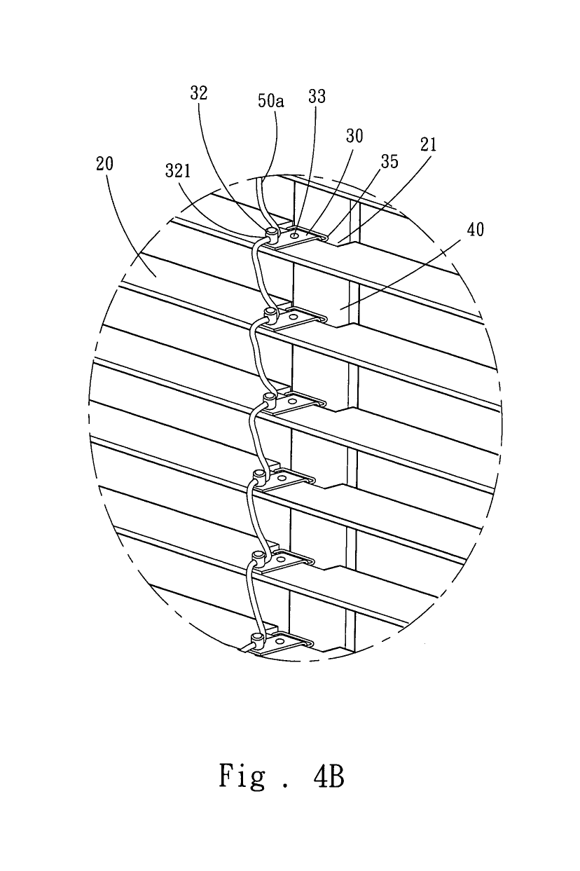

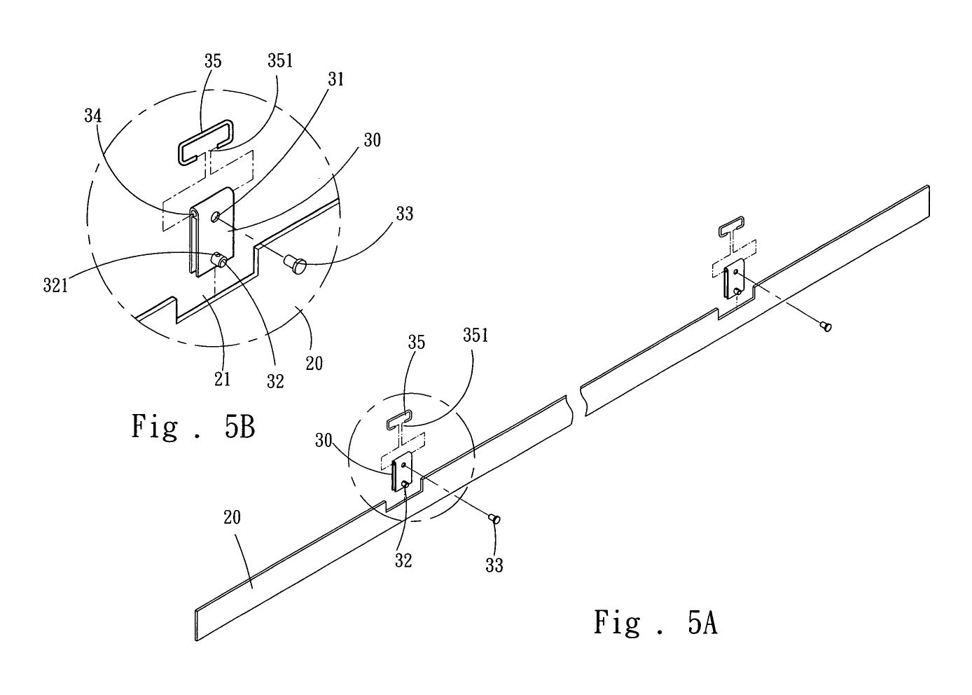

a plurality of transverse slats 20 (referring to FIGS. 4A and 4B) located beneath the upper rail 10 in a longitudinal manner. Each of the slats 20 has a notch 21 on the left side and the right side (referring to FIG. 5A) adjacent to the front edge of the slat 20;

a blade type fastening element 30 (referring to FIGS. 5A and 5B) which has two apertures 31 on a front side and a rear side. The aperture 31 on the rear side is coupled with a sleeve 32 to run through the slat 20. The aperture 31 on the front side receives a fastening member 33 (such as a rivet) to run through the slat 20 to fasten the fastening element 30 on the front edge of the slat 20. The fastening element 30 has a hole 34 on the front edge to be coupled with a retaining ring 35 which is substantially rectangular with an opening 351 on a rear side. The opening 351 is smaller than the width of the retaining ring 35. The sleeve 32 has a radial thread hole 321;

two trapezoidal bands 40 connecting to the slats 20 on the front side thereof;

a first light regulation rope 50a and a second light regulation rope 50b (referring to FIGS. 3, 4A and 6). The first light regulation rope 50a runs through the thread hole 321 of the sleeve 32 of the fastening element 30 on the left side of each slat 20 and the anchor pulley 12a on the left side and winds around the check pulley 11a and passes through the face panel 13 to become pedant on the front side. The second light regulation rope 50b runs through the thread hole 321 of the sleeve 32 of the fastening element 30 on the right side of each slat 20 and the anchor pulley 12b on the right side and winds around the check pulley 11b on the left side and passes through the face panel 13 to become parallel with the first light regulation rope 50a in a pedant manner. The first and second light regulation ropes 50a and 50b have distal ends jointly fastened to a handle 51; and

a first lift cord 60a and a second lift cord 60b adopted on a rolling type shade (referring to FIGS. 3, 4A and 6). The first lift cord 60a has a distal end fastened to the lowest slat 20 on the front and right side, and wound around another anchor pulley 12c on the right side of the upper rail 10 and the check pulley 11b on the right side, then dropped in a pendant manner. The second lift cord 60b has another distal end fastened to the lowest slat 20 on the front and left side, and wound around other anchor pulley 12d on the left side and another anchor pulley 12c on the right side of the upper rail 10, and the check pulley 11b on the right side, then dropped in a pedant manner. The distal ends of the first and second lift cords 60a and 60b are jointly fastened to another handle 61.

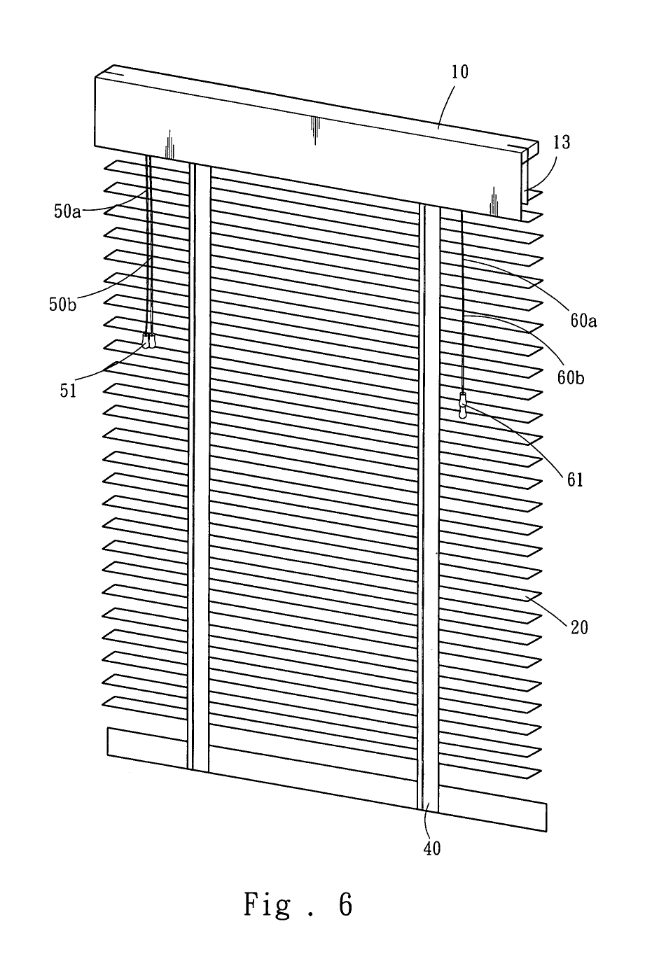

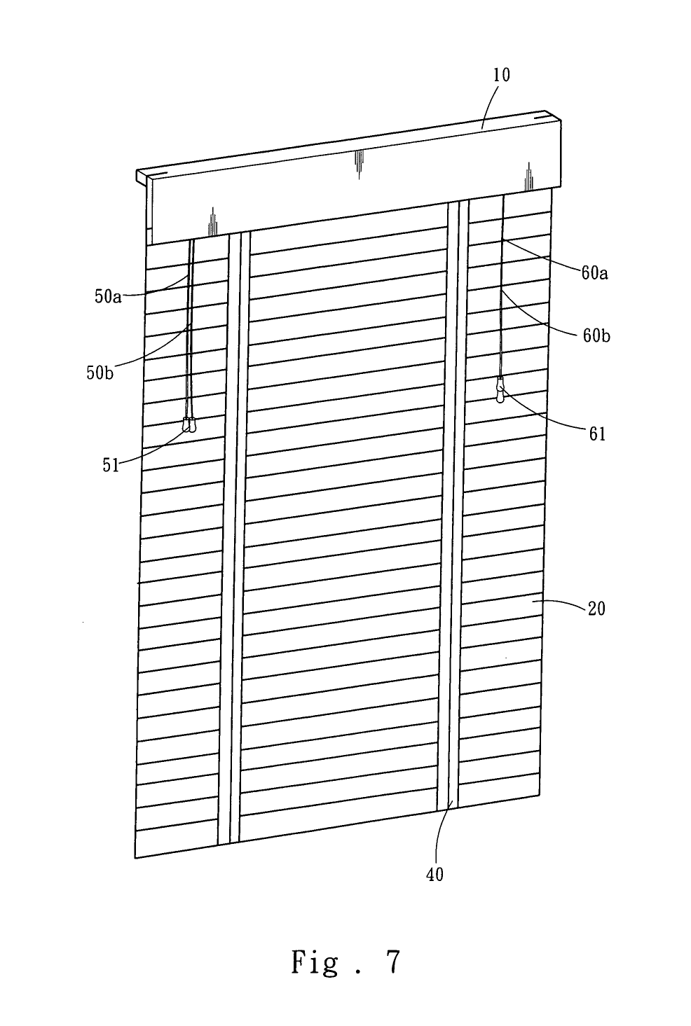

As the first and second light regulation ropes 50a and 50b are connected respectively to the fastening elements 30 on the left and right sides of the slat 20, by pulling the handle 51 the first and second light regulation ropes 50a and 50b can be moved at the same time to drive the slats 20 horizontally to form spaced intervals among them as shown in FIG. 6 to receive full light projection. The first and second light regulation ropes 50a and 50b are clipped and anchored by the check pulley 11a (the structure of the check pulley 11a is known in the art, details are omitted).

When the first and second light regulation ropes 50a and 50b are released, the natural gravity force of the slats 20 tilts the slats 20 towards one side so that neighboring up and down slats 20 are folded and stacked on the juncture as shown in FIG. 7 to block light from entering indoors. By clipping the first and second light regulation ropes 50a and 50b through the check pulley 11a, the slats 20 can be tilted and anchored as desired. The slats 20 may also be tilted at a desired inclined angle to fully block light projection or allow light to partially enter indoors and provide air circulation effect. Thus by pulling the handle 51 below the first and second light regulation ropes 50a and 50b, the slats 20 can be moved horizontally at the same time to achieve light projection and air circulation effect. By lowering the first and second light regulation ropes 50a and 50b, the slats 20 can be tilted as desired to adjust light projection. Operation is simple.

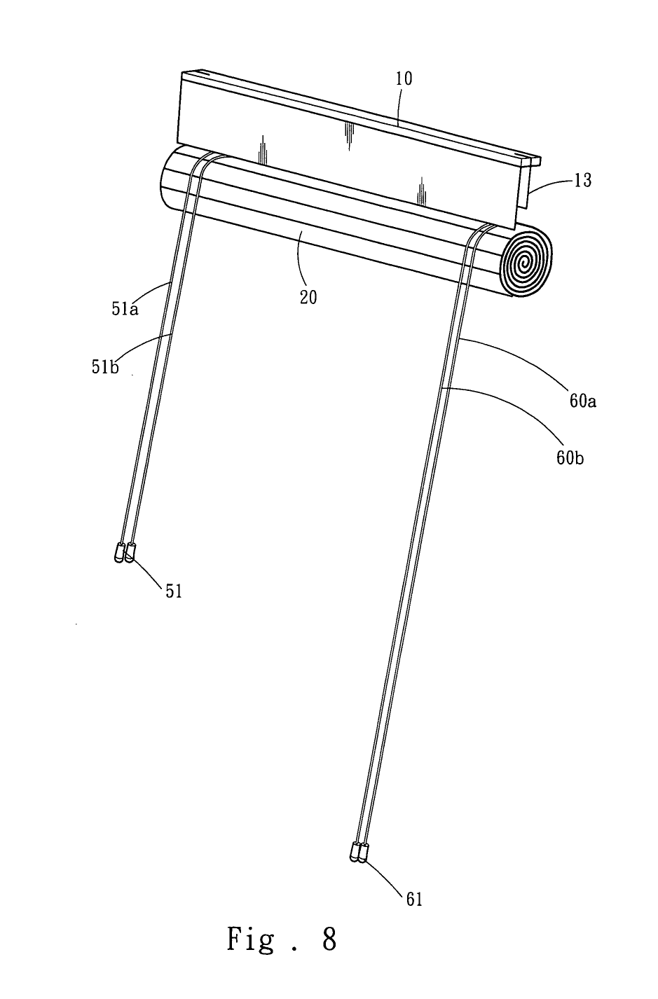

For retraction, pull another handle 61, the lowest slat 20 is driven upwards by the first lift cord 60a and the second lift cord 60b, and the slats 20 are rolled upwards like a barrel as shown in FIG. 8, and are anchored by the check pulley 11b on one side of the upper rail 10.

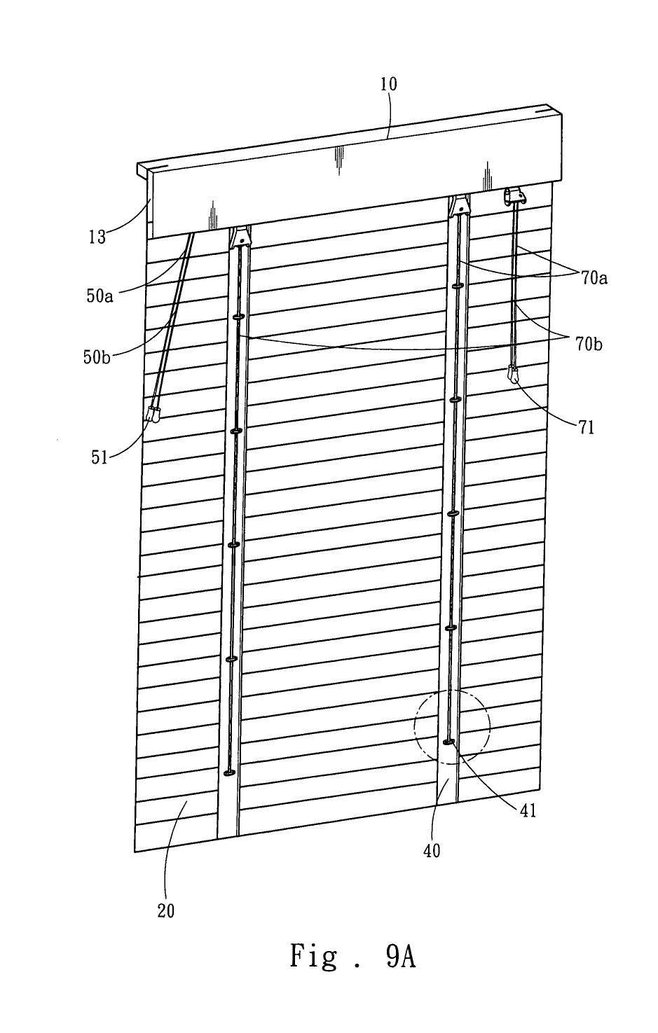

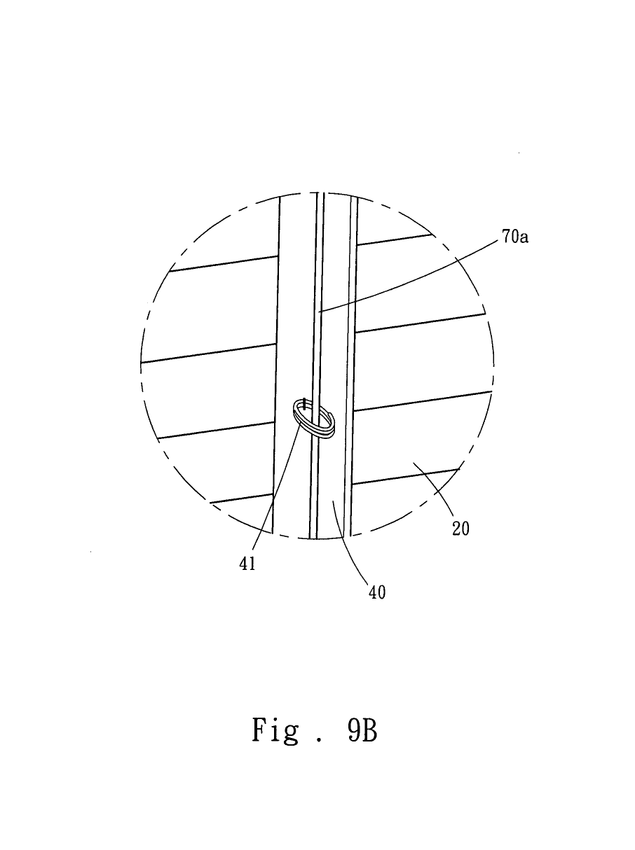

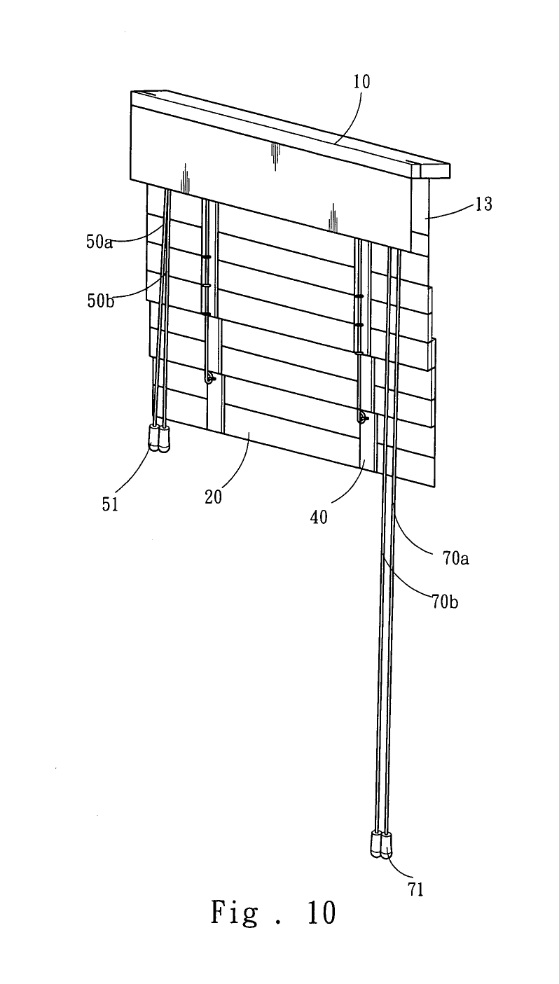

Refer to FIGS. 9A and 9B for the invention adopted on a roman shade blind. It is largely constructed like the one for the rolling shade previously discussed. To adjust the light regulation angle of the slats 20, pull the handle 51 below the first and second light regulation ropes 50a and 50b to make the slats 20 horizontal or at an inclined angle like that for the rolling shade. The main difference is that the roman shade blind has trapezoidal bands 40 on two sides each has anchor rings 41 at selected intervals. There are a first lift cord 70a and a second lift cord 70b threading through the anchor rings 41. By pulling a handle 71, the lowest anchor ring 41 is moved upwards to be in contact with another anchor ring 41 on an upper side, then the another anchor ring 41 on the upper side is moved upwards again. By means of such an approach, the trapezoidal bands 40 can be folded in a multiple-stage manner to retract and fold the slats 20 as shown in FIG. 10.

Prototypes of the invention have been made and tested according to the specifications set forth above. Test results proved that the object and functions are accomplished satisfactorily. It offers a significant improvement over the conventional techniques.

What is claimed is:

1. A light regulation structure for slats of shades, comprising:
an upper rail which has a check pulley on each of two sides and a pair of anchor pulleys on a front side and a rear side on the bottom thereof in a pedant manner to be wound around by a first light regulation rope, a second light regulation rope, a first lift cord, and a second lift cord;
a plurality of slats which are located beneath the upper rail and have respectively a fastening element on a left side and a right side, the fastening element having a thread hole on one side to be threaded through by the first light regulation rope or the second light regulation rope and a retaining ring on an outer side; and
two trapezoidal bands connecting to the left side and the right side of the slats.

2. The light regulation structure for slats of shades of claim 1, wherein the fastening element is a blade to clip a front edge of each slat through a sleeve, the thread hole being located radially in the sleeve, the fastening element further having an aperture on a front side thereof to couple with the retaining ring.

3. The light regulation structure for slats of shades of claim 2, wherein the retaining ring is rectangular and has an opening on a rear side smaller than the width of retaining ring.

4. The light regulation structure for slats of shades of claim 2, wherein the fastening element has two apertures, one of the apertures holding the sleeve, another aperture holding a fastening member, the sleeve and the fastening member jointly anchoring the fastening element on the slat.

5. The light regulation structure for slats of shades of claim 2, wherein the first light regulation rope runs through the thread hole of the sleeve of the fastening element on one side of each slat and the anchor pulley on one side of the upper rail and winds around the check pulley on the one side of the upper rail to become pedant and has one distal end fastened to a handle, and the second light regulation rope runs through the thread hole of the sleeve of the fastening element on another side of each slat and the anchor pulley on the another side of the upper rail and winds around the check pulley to become parallel with the first light regulation rope in a pedant manner and has another distal end jointly fastened to the handle.
